(19) United States
(12) Patent Application Publication
(10) Pub. No.: US 2022/0335486 A1
(43) Pub. Date: Oct. 20, 2022

(54) JOB EXECUTION APPARATUS AND INFORMATION PROCESSING SYSTEM GENERATING AGGREGATED DATA REGARDING EXECUTED JOB, AND NON-TRANSITORY COMPUTER READABLE RECORDING MEDIUM STORING DATA PROCESSING PROGRAM

(71) Applicant: KYOCERA Document Solutions Inc., Osaka (JP)

(72) Inventors: Ryuichi ISHIZU, Osaka (JP); Yumi NAKAGOSHI, Osaka (JP)

(73) Assignee: KYOCERA Document Solutions Inc., Osaka (JP)

(21) Appl. No.: 17/712,244

(22) Filed: Apr. 4, 2022

(30) Foreign Application Priority Data
Apr. 15, 2021 (JP) 2021-068971

(51) Int. Cl. G06Q 30/02; G06F 3/12

(52) U.S. Cl. CPC G06Q 30/0283; G06F 3/1204; G06F 3/1273; G06F 3/1287

(57) ABSTRACT

An image processing apparatus includes a job execution device that executes jobs, an aggregated data generator that generates aggregated data indicating an aggregated result of a quantity for each type of job executed by the job execution device, and an aggregated data transmitter that transmits the aggregated data generated by the aggregated data generator to a charge amount calculation system, in which, in a case where the unit price of the job is changed, the aggregated data generator separately generates the aggregated data of the job before the change of the unit price and the aggregated data after the change of the unit price and stores the unit price corresponding to the generated aggregated data, and the aggregated data transmitter associates the aggregated data with the unit price corresponding to this aggregated data and transmits the association result to the charge amount calculation system.

### INCORPORATION BY REFERENCE

This application claims priority to Japanese Patent Application No. 2021-068971 filed on Apr. 15, 2021, the entire contents of which are incorporated by reference herein.

### BACKGROUND

The present disclosure relates to a job execution apparatus, an information processing system, and a non-transitory computer readable recording medium that stores a data processing program.

There is an information processing system including a job execution apparatus that executes a job and a charge amount calculation system that calculates a charge amount in the job execution apparatus. In this information processing system, aggregated data indicating an aggregated result of a quantity in the billing unit (hereinafter, referred to as a “billing quantity”) in the job executed by the job execution apparatus is received by the charge amount calculation system.

### SUMMARY

As one aspect of the present disclosure, a technique that is a further improvement of the above technique is proposed.

A job execution apparatus according to one aspect of the present disclosure is a job execution apparatus that executes jobs. The job execution apparatus includes a control device. The control device includes a processor, and functions as a job execution device, an aggregated data generator, and an aggregated data transmitter by the processor executing an information processing program. The job execution device executes the jobs. The aggregated data generator generates aggregated data indicating an aggregated result of a quantity for each type of job that is a target of charging with respect to each of the jobs executed by the job execution device. The aggregated data transmitter transmits each piece of the aggregated data generated by the aggregated data generator to a charge amount calculation system that calculates a charge amount in the job execution apparatus. In a case where a unit price of the charging for any of the jobs is changed, the aggregated data generator separately generates the aggregated data for a job executed before the unit price is changed and the aggregated data for a job executed after the unit price is changed, and stores the unit price corresponding to each of the pieces of generated aggregated data. The aggregated data transmitter associates each of the pieces of aggregated data before and after the unit price is changed with the unit price corresponding to each of the pieces of aggregated data and transmits the aggregated data to the charge amount calculation system.

An information processing system according to another aspect of the present disclosure includes the job execution apparatus and a charge amount calculation system that calculates a charge amount in the job execution apparatus. The job execution apparatus includes the control device. The control device functions as the job execution device, the aggregated data generator, and the aggregated data transmitter by the processor executing an information processing program.

A non-transitory computer readable recording medium according to still another aspect of the present disclosure stores a data processing program. The data processing program is executed by a computer to cause the computer to function as an aggregated data generator and an aggregated data transmitter. The aggregated data generator generates aggregated data indicating an aggregated result of a quantity for each type of job that is a target of charging with respect to each of the jobs executed by the computer. The aggregated data transmitter transmits each piece of the aggregated data generated by the aggregated data generator to a charge amount calculation system that calculates a charge amount in the job execution apparatus. In a case where a unit price of the charging for any of the jobs is changed, the aggregated data generator separately generates the aggregated data for a job executed before the unit price is changed and the aggregated data for a job executed after the unit price is changed, and stores the unit price corresponding to each of the pieces of generated aggregated data. The aggregated data transmitter associates each of the pieces of aggregated data before and after the unit price is changed with the unit price corresponding to each of the pieces of aggregated data and transmits the aggregated data to the charge amount calculation system.

### BRIEF DESCRIPTION OF THE DRAWINGS

FIG. 1 is a block diagram of an information processing system according to an embodiment of the present disclosure.

FIG. 2 is a block diagram of an image processing apparatus shown in FIG. 1 in a case where the image processing apparatus is an MFP.

FIG. 3 is a diagram showing an example of a printing fee table shown in FIG. 2.

FIG. 4 is a diagram showing an example of a scanning fee table shown in FIG. 2.

FIG. 5 is a diagram showing an example of a job history shown in FIG. 2.

FIG. 6 is a diagram showing an example of an aggregated data shown in FIG. 2.

FIG. 7 is a diagram showing an example of correspondence relationship information shown in FIG. 2.

FIG. 8 is a diagram showing an example of a counter shown in FIG. 2.

FIG. 9 is a block diagram of a charge amount calculation system shown in FIG. 1 in a case of being configured by a single computer.

FIG. 10 is a flowchart showing an operation of the image processing apparatus shown in FIG. 2 in a case where a job is executed.

FIG. 11 is a flowchart showing an operation of the image processing apparatus shown in FIG. 2 in a case where aggregated data is periodically generated.

FIG. 12 is a flowchart showing an operation of the image processing apparatus shown in FIG. 2 in a case where a charging table is updated.

FIG. 13 is a flowchart showing an operation of the image processing apparatus shown in FIG. 2 in a case where a log is transmitted to the charge amount calculation system.

FIG. 14 is a diagram showing an example of a relationship between aggregated data and a log in a case where the image processing apparatus shown in FIG. 2 generates a plurality of logs.

FIG. 15 is a diagram showing an example of a log generated by the image processing apparatus shown in FIG. 2.

FIG. 16 is a flowchart showing an operation of the charge amount calculation system shown in FIG. 9 in a case where a log is received.

FIG. 17 is a flowchart showing an operation of the charge amount calculation system shown in FIG. 9 in a case where a charge amount in the image processing apparatus is calculated.

### DETAILED DESCRIPTION

Hereinafter, a job execution apparatus, an information processing system, and a non-transitory computer readable recording medium storing a data processing program according to an embodiment as an aspect of the present disclosure will be described with reference to the drawings.

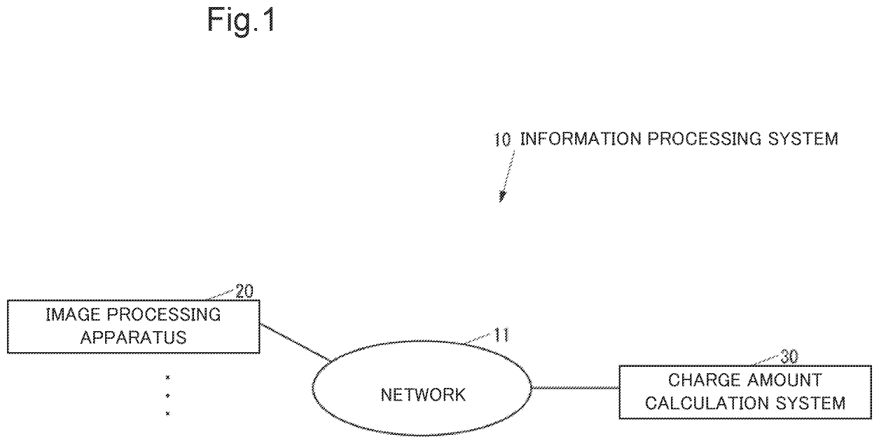

First, a configuration of an information processing system according to an embodiment of the present disclosure will be described. FIG. 1 is a block diagram of an information processing system 10 according to the present embodiment.

As shown in FIG. 1, the information processing system 10 includes an image processing apparatus 20 as a job execution apparatus that executes a job, and a charge amount calculation system 30 that calculates a charge amount in the image processing apparatus. The information processing system 10 may include an image processing apparatus as a job execution apparatus in addition to the image processing apparatus 20.

For example, the image processing apparatus in the information processing system 10 is disposed in a retail store such as a convenience store or a public institution such as a school. As the image processing apparatus in the information processing system 10, for example, an image forming apparatus such as a multifunction peripheral (MFP), a copy-only machine, or a printer-only machine, or a scanner-only machine may be employed.

The image processing apparatus in the information processing system 10 normally executes charging each time it is used. For example, this charging may be settled via a charging system (not shown) attached to the image processing apparatus, or, in a case where the image processing apparatus is located at a retail store, may be settled at the retail store's cash register. For example, as a charging system, a coin vendor that can make payments in cash, and a kiosk terminal that can make non-cash payments, such as credit card payments, may be employed.

The charge amount calculation system 30 may be configured with a single computer or may be configured with a plurality of computers.

The image processing apparatus in the information processing system 10 and the charge amount calculation system 30 can communicate with each other via a network 11 such as the Internet.

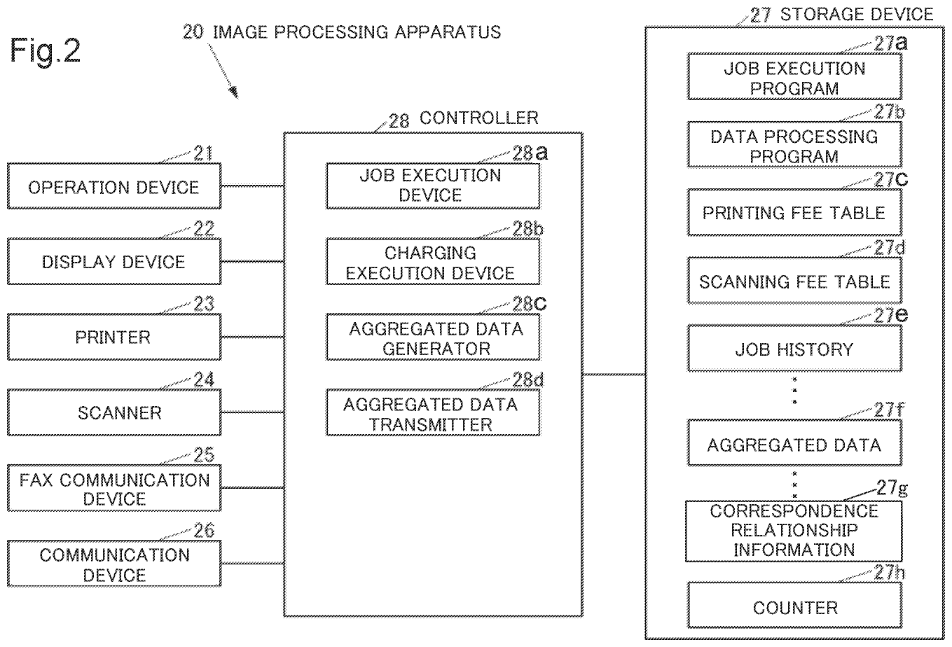

FIG. 2 is a block diagram of the image processing apparatus 20 in a case of an MFP.

As shown in FIG. 2, the image processing apparatus 20 includes an operation device 21 that is an operation device such as a button into which various operations are input, a display device 22 that is a display device such as a liquid crystal display (LCD) that displays various types of information, a printer 23 that is a printing device that prints an image on a recording medium such as paper, a scanner 24 that is a reading device that reads an image from an original, a fax communication device 25 that is a fax device that performs fax communication with an external facsimile machine (not shown) via a communication line such as a public telephone line, a communication device 26 that is a communication device that performs communication with an external apparatus via a network such as a local area network (LAN) or the Internet, or directly performs communication by wire or wirelessly without a network, a storage device 27 that is a nonvolatile storage device such as a semiconductor memory or a hard disk drive (HDD) that stores various types of information, and a controller 28 that controls the entire image processing apparatus 20.

The storage device 27 is, for example, an HDD or an SSD, and stores a job execution program 27a for executing various jobs and a data processing program 27b for processing aggregated data indicating an aggregated result of a quantity for each type of job (hereinafter, referred to as “billing quantity”). The job execution program 27a and the data processing program 27b may be installed in the image processing apparatus 20 in a manufacturing stage of the image processing apparatus 20, may be additionally installed in the image processing apparatus 20 from an external storage medium such as a Universal Serial Bus (USB) memory, or may be additionally installed in the image processing apparatus 20 from a network. The job execution program 27a and the data processing program 27b may be combined into one program.

As a charging table indicating a fee system used for charging, the storage device 27 may include a printing fee table 27c indicating a fee system for printing an image on a recording medium, and a scanning fee table 27d indicating a fee system for reading, that is, scanning, an image from an original.

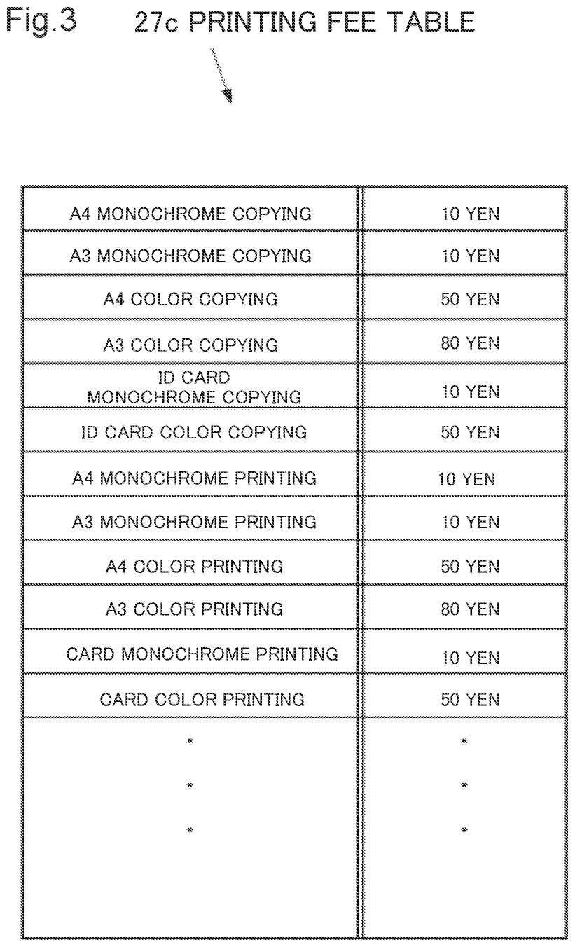

FIG. 3 is a diagram showing an example of the printing fee table 27c.

The printing fee table 27c shown in FIG. 3 includes the unit price of normal monochrome copying of A4 size (hereinafter, referred to as “A4 monochrome copying”), the unit price of normal monochrome copying of A3 size (hereinafter, referred to as “A3 monochrome copying”), the unit price of normal color copying of A4 size (hereinafter, referred to as “A4 color copying”), the unit price of a normal color copying of A3 size (hereinafter, referred to as “A3 color copying”), the unit price of monochrome copying in ID card copying for collecting and copying both sides of an ID card such as a driver's license or a health insurance card on one side of one recording medium (hereinafter, referred to as “ID card monochrome copying”), the unit price of color copying in the ID card copying (hereinafter, referred to as “ID card color copying”), the unit price of monochrome printing in normal printing of A4 size based on data acquired from the outside such as data acquired from an external storage medium such as a USB memory or data acquired via a network (hereinafter, referred to as “A4 monochrome printing”), the unit price of monochrome printing in normal printing of A3 size based on data acquired from the outside (hereinafter, referred to as “A3 monochrome printing”), the unit price of color printing in the normal printing of A4 size based on data acquired from the outside (hereinafter, referred to as “A4 color printing”), the unit price of color printing in the normal printing of A3 size based on data acquired from the outside (hereinafter, referred to as “A3 color printing”), the unit price of monochrome printing in card printing for performing printing on a card-type recording medium (hereinafter, referred to as “card monochrome printing”), and the unit price of color printing in the card printing (hereinafter, referred to as “card color printing”).

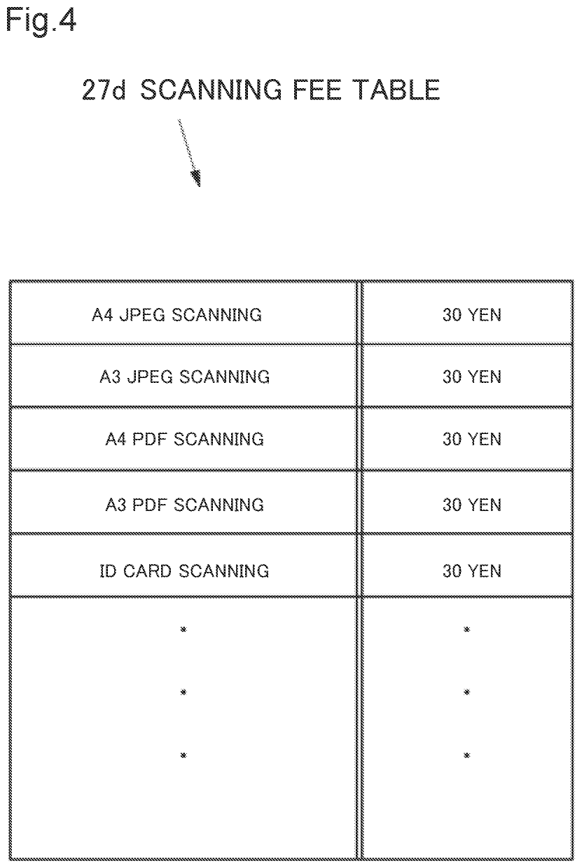

FIG. 4 is a diagram showing an example of the scanning fee table 27d.

The scanning fee table 27d shown in FIG. 4 includes the unit price of scanning for reading an A4 size original to generate a Joint Photographic Experts Group (JPEG) file (hereinafter, referred to as “A4 JPEG scanning”), the unit price of scanning for reading an A3 size original to generate a JPEG file (hereinafter, referred to as “A3 JPEG scanning”), the unit price of scanning for reading an A4 size original to generate a Portable Document Format (PDF) file (hereinafter, referred to as “A4 PDF scanning”), the unit price of scanning for reading an A3 size original to generate a PDF file (hereinafter, referred to as “A3 PDF scanning”), and the unit price of scanning for reading an ID-card-sized original to generate an image file (hereinafter, referred to as “ID card scanning”).

As shown in FIG. 2, the storage device 27 may store a job history 27e indicating an execution result of each job. The storage device 27 may store a job history in addition to the job history 27e.

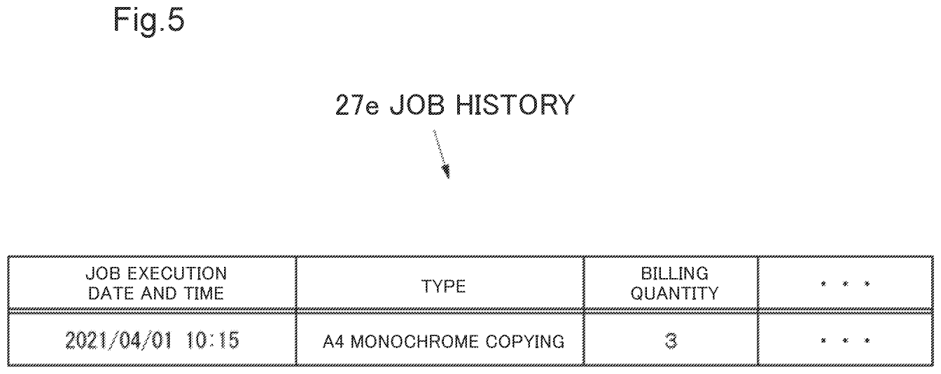

FIG. 5 is a diagram showing an example of the job history 27e.

The job history 27e shown in FIG. 5 includes the execution date and time of a job, the type of job, and a billing quantity in the job. Here, a billing quantity is the number of print pages in the executed job in a case where the type of job is copying or printing, and is the number of image pages in an image file generated in the executed job in a case where the type of job is scanning. In a case where the type of job is copying or printing, the job history 27e may include the number of printed copies in the executed job. For example, in double-sided printing on one recording medium, the number of printed pages is a total of two pages including one on the front side and one on the back side, but the number of printed copies is one. When the type of job is a fax transmission job, the job history 27e may include a fax number of a transmission destination.

As shown in FIG. 2, the storage device 27 may store aggregated data 27f indicating an aggregated result based on the job history. The storage device 27 can store aggregated data in addition to the aggregated data 27f.

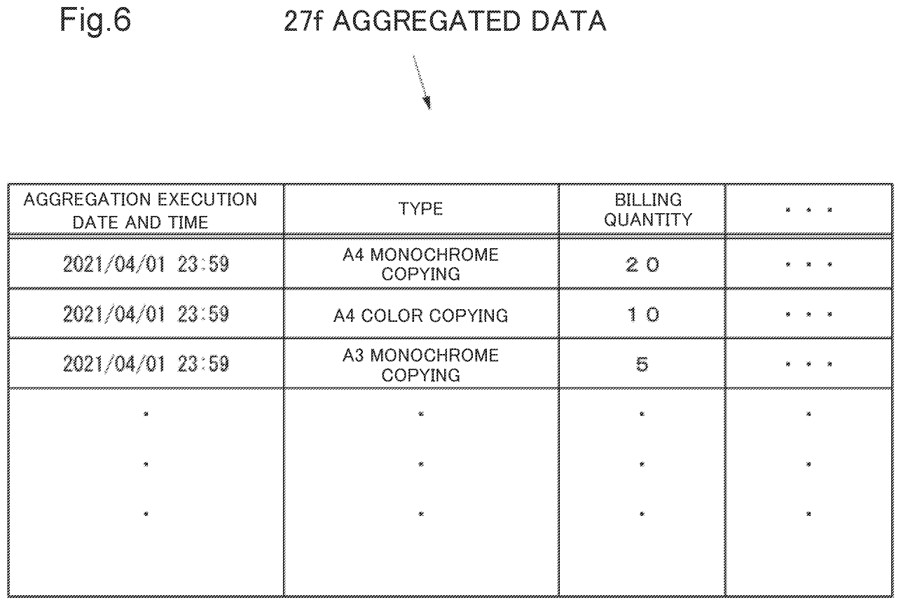

FIG. 6 is a diagram showing an example of the aggregated data 27f.

The aggregated data 27f shown in FIG. 6 includes the aggregation execution date and time, the type of job, and a billing quantity.

As shown in FIG. 2, the storage device 27 may store correspondence relationship information 27g indicating a correspondence relationship between the aggregated data and the charging table.

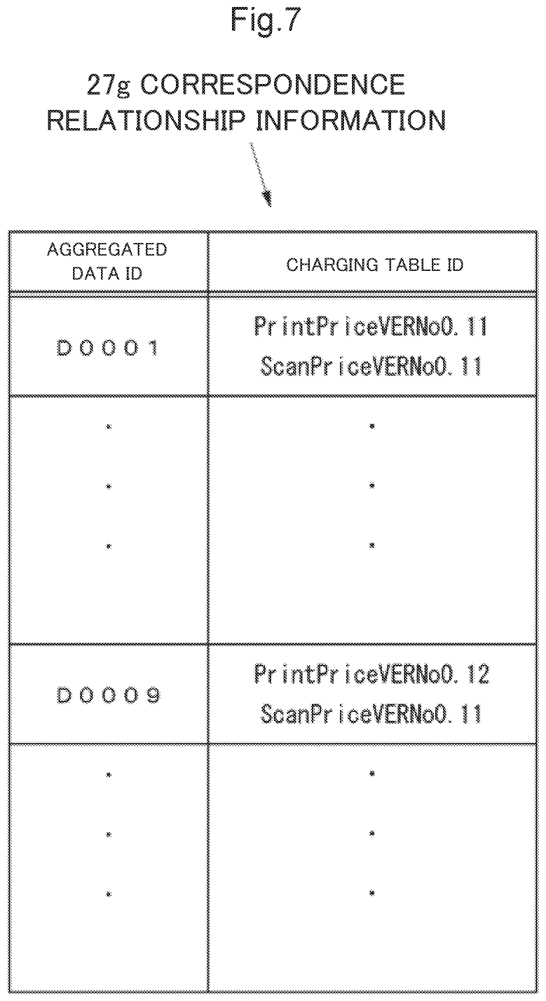

FIG. 7 is a diagram showing an example of the correspondence relationship information 27g.

The correspondence relationship information 27g shown in FIG. 7 indicates an aggregated data ID as identification information of aggregated data and a charging table ID as identification information of a charging table for each piece of aggregated data. In FIG. 7, “PrintPriceVERNo0.11” and “PrintPriceVERNo0.12” indicate that the charging table IDs of the printing fee table 27c are “0.11” and “0.12”, respectively, and “ScanPriceVERNo0.11” indicates that a charging table ID of the scanning fee table 27d is “0.11”.

As shown in FIG. 2, the storage device 27 may store a counter 27h indicating an execution result (count value) in total for each type of job (a total of printed copies for each type of job).

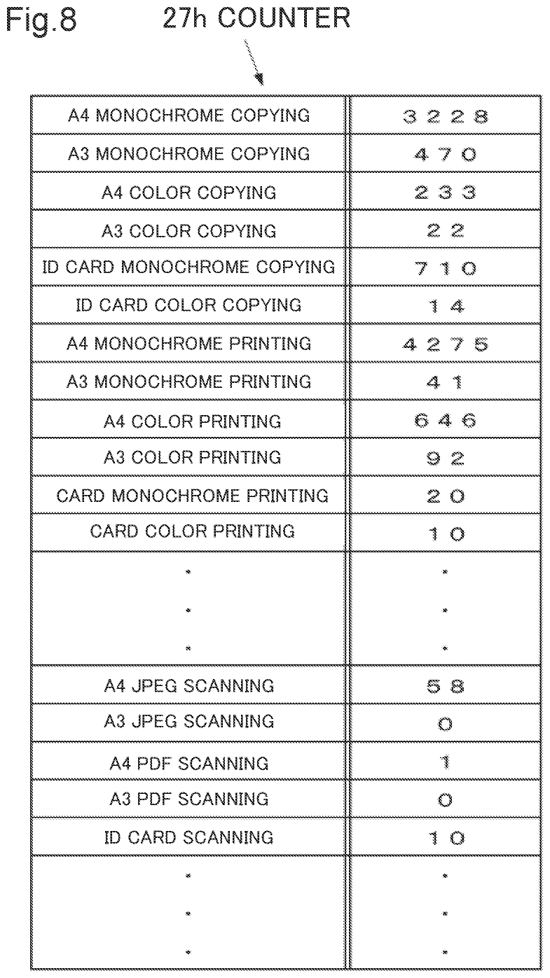

FIG. 8 is a diagram showing an example of the counter 27h.

The counter 27h shown in FIG. 8 includes a total quantity of A4 monochrome copying, a total quantity of A3 monochrome copying, a total quantity of A4 color copying, a total quantity of A3 color copying, a total quantity of ID card monochrome copying, a total quantity of ID card color copying, a total quantity of A4 monochrome printing, a total quantity of A3 monochrome printing, a total quantity of A4 color printing, a total quantity of A3 color printing, a total quantity of card monochrome printing, a total quantity of card color printing, a total quantity of A4 JPEG scanning, a total quantity of A3 JPEG scanning, a total quantity of A4 PDF scanning, a total quantity of A3 PDF scanning, and a total quantity of ID card scanning. Here, a total quantity is a total number of printed pages by the executed job when the type of job is copying or printing, and is a total number of pages of images in the image file generated in the executed job when the type of job is scanning.

The controller 28 shown in FIG. 2 includes, for example, a central processing unit (CPU), a read only memory (ROM) storing a program and various types of data, and a random access memory (RAM) that is a memory used as a work area of the CPU of the controller 28. Therefore, the image processing apparatus 20 configures a computer. The CPU of the controller 28 executes a program stored in the storage device 27 or the ROM of the controller 28.

The controller 28 functions as a job execution device 28a for executing a job and a charging execution device 28b executing charging by the CPU executing the job execution program 27a.

The controller 28 further functions as an aggregated data generator 28c that generates aggregated data and the aggregated data transmitter 28d that transmits the aggregated data to the charge amount calculation system 30 (refer to FIG. 1) by the CPU executing the data processing program 27b.

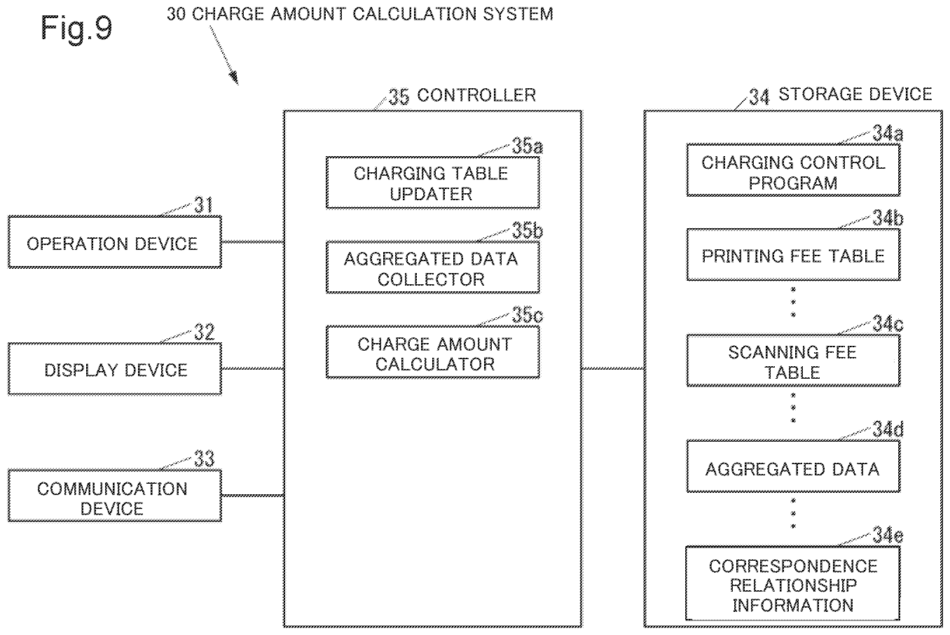

FIG. 9 is a block diagram of the charge amount calculation system 30 in a case of being configured by a single computer.

The charge amount calculation system 30 shown in FIG. 9 has an operation device 31 that is an operation device such as a keyboard and a mouse into which various operations are input, a display device 32 that is a display device such as an LCD that displays various types of information, a communication device 33 that is a communication device that performs communication with an external apparatus via a network such as a LAN or the Internet, or directly performs communication by wire or wirelessly without a network, a storage device 34 that is a nonvolatile storage device such as a semiconductor memory or an HDD that stores various types of information, and a controller 35 that controls the entire charge amount calculation system 30.

The storage device 34 is, for example, an HDD or an SSD, and stores a charging control program 34a for controlling charging in the image processing apparatus. The charging control program 34a may be installed in the charge amount calculation system 30 in a manufacturing stage of the charge amount calculation system 30, may be additionally installed in the charge amount calculation system 30 from an external storage medium such as a USB memory, or may be additionally installed in the charge amount calculation system 30 from the network.

The storage device 34 may store the printing fee table 34b as a charging table. The storage device 34 may store a printing fee table in addition to the printing fee table 34b. A configuration of the printing fee table stored in the storage device 34 is the same as the configuration of the printing fee table 27c (refer to FIG. 3).

The storage device 34 may store the scanning fee table 34c as a charging table. The storage device 34 may store a scanning fee table in addition to the scanning fee table 34c. A configuration of the scanning fee table stored in the storage device 34 is the same as the configuration of the scanning fee table 27d (refer to FIG. 4).

The storage device 34 may store aggregated data 34d. The storage device 34 may store aggregated data in addition to the aggregated data 34d. A configuration of the aggregated data stored in the storage device 34 is the same as the configuration of the aggregated data 27f (refer to FIG. 6).

The storage device 34 may store correspondence relationship information 34e indicating a correspondence relationship between aggregated data and a charging table. A configuration of the correspondence relationship information 34e is the same as the configuration of the correspondence relationship information 27g (refer to FIG. 7).

The controller 35 includes, for example, a CPU, a ROM storing programs and various pieces of data, and a RAM that is a memory used as a work area of the CPU of the controller 35. The CPU of the controller 35 executes the program stored in the storage device 34 or the ROM of the controller 35.

The controller 35 functions as a charging table updater 35a that causes the image processing apparatus to update the charging table, an aggregated data collector 35b that collects aggregated data from the image processing apparatus, and a charge amount calculator 35c that calculates a charge amount in the image processing apparatus, by the CPU executing the charging control program 34a.

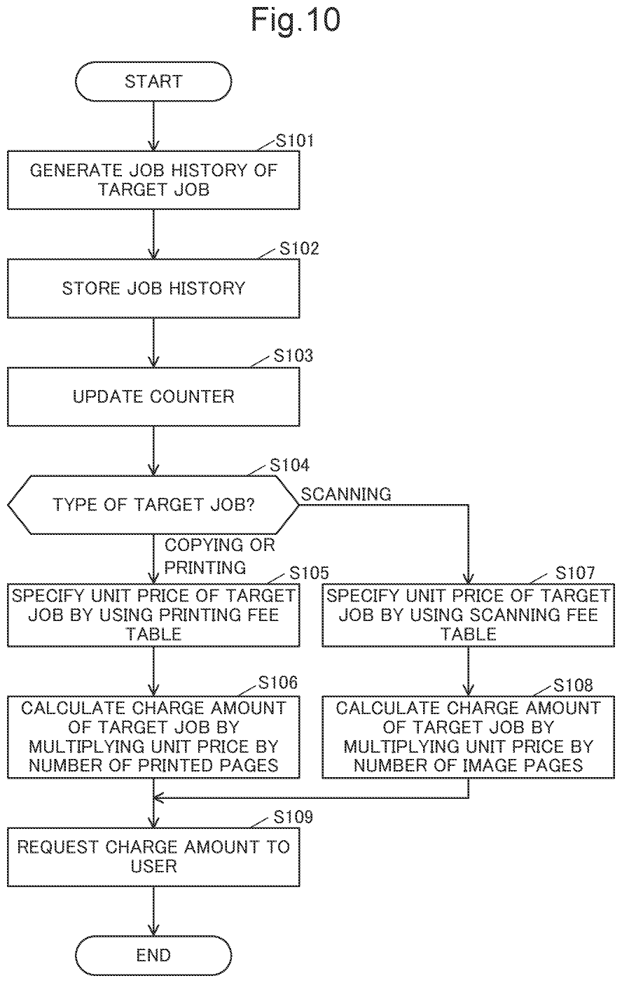

Next, an operation of the information processing system 10 will be described. First, an operation of the image processing apparatus 20 in a case where a job is executed will be described. FIG. 10 is a flowchart showing an operation of the image processing apparatus 20 in a case where a job is executed.

The aggregated data generator 28c of the image processing apparatus 20 executes the operation shown in FIG. 10 each time the job execution device 28a executes a copying, printing, or scanning job in response to an instruction from a user.

As shown in FIG. 10, the aggregated data generator 28c generates a job history indicating an execution result in an executed job (hereinafter, referred to as a “target job” in the description of the operation shown in FIG. 10) (S101), and stores the job history generated in S101 in the storage device 27 (S102).

Next, the job execution device 28a updates the counter 27h according to the execution result of the target job (S103).

Next, the charging execution device 28b determines the type of the target job (S104).

The charging execution device 28b determines in S104 which function the target job executes, and in a case where it is determined in S104 that the function to be executed is a copying or printing job, specifies the unit price of the target job by using the printing fee table 27c (S105).

Next, the charging execution device 28b calculates a charge amount of the target job by multiplying the unit price specified in S105 by the number of printed pages in the target job (S106).

In a case where it is determined in S104 that the function to be executed is a scanning job for the target job, the charging execution device 28b specifies the unit price of the target job by using the scanning fee table 27d (S107).

Next, the charging execution device 28b calculates a charge amount of the target job by multiplying the unit price specified in S107 by the number of image pages in the image file generated in the target job (S108).

When the process in S106 or S108 is finished, the charging execution device 28b executes a process necessary for requesting the charge amount calculated in S106 or S108 to a user (S109), and finishes the operation shown in FIG. 10.

Next, an operation of the image processing apparatus 20 in a case where aggregated data is periodically generated will be described.

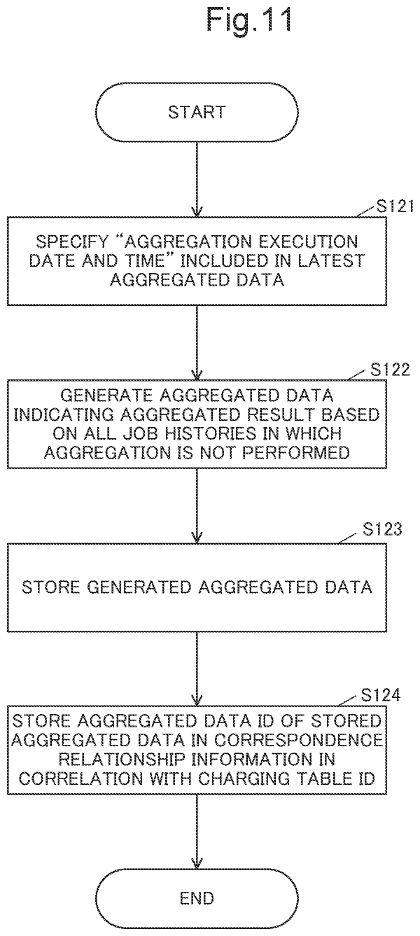

FIG. 11 is a flowchart showing an operation of the image processing apparatus 20 in a case where aggregated data is periodically generated.

The aggregated data generator 28c of the image processing apparatus 20 periodically executes the operation shown in FIG. 11, for example, at 11:59 pm every day.

As shown in FIG. 11, the aggregated data generator 28c specifies the “aggregation execution date and time” included in the latest aggregated data stored in the storage device 27 (S121).

Next, the aggregated data generator 28c generates aggregated data indicating an aggregated result based on all job histories in which the “job execution date and time” is after the “aggregation execution date and time” specified in S121 among the job histories stored in the storage device 27, that is, all job histories in which aggregation is not performed yet (S122), and stores the aggregated data generated in S122 in the storage device 27 (S123).

Next, the aggregated data generator 28c correlates an aggregated data ID of the aggregated data stored in S123 with the respective charging table IDs of the printing fee table 27c and the scanning fee table 27d stored in the storage device 27 and stores the correlation results in the correspondence relationship information 27g (S124), and finishes the operation shown in FIG. 11.

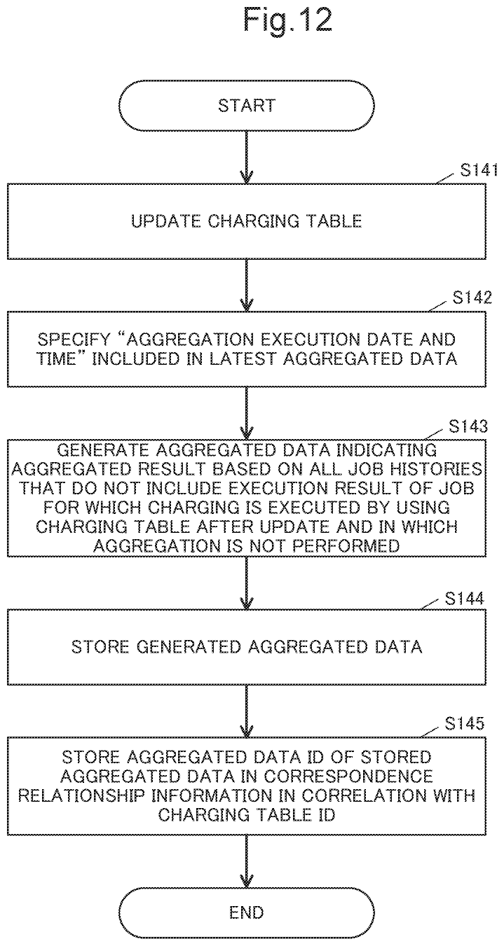

Next, an operation of the image processing apparatus 20 in a case where a charging table is updated will be described. FIG. 12 is a flowchart showing an operation of the image processing apparatus 20 in a case where a charging table.

For example, when the charging table updater 35a of the charge amount calculation system 30 is instructed to update a charging table of the image processing apparatus 20 via the operation device 31 or the communication device 33, the charging table updater 35a transmits the instruction for updating the charging table (hereinafter, a “charging table update instruction”) to the image processing apparatus 20. Here, the charging table updater 35a causes a new charging table that is an update target among the charging tables stored in the storage device 34 to be included in the charging table update instruction. Upon receiving the charging table update instruction transmitted from the charge amount calculation system 30, the charging execution device 28b of the image processing apparatus 20 executes the operation shown in FIG. 12.

As shown in FIG. 12, the charging execution device 28b updates the charging table stored in the storage device 27 to the charging table included in the charging table update instruction received from the charge amount calculation system 30 (S141). That is, in a case where the charging table update instruction includes a printing fee table, the charging execution device 28b updates the printing fee table 27c stored in the storage device 27 to the printing fee table included in the charging table update instruction. In a case where the charging table update instruction includes a scanning fee table, the charging execution device 28b updates the scanning fee table 27d stored in the storage device 27 to the scanning fee table included in the charging table update instruction.

After the process in S141, the aggregated data generator 28c specifies the “aggregation execution date and time” included in the latest aggregated data stored in the storage device 27 (S142).

Next, the aggregated data generator 28c generates aggregated data indicating an aggregated result based on all job histories in which the “job execution date and time” is after the “aggregation execution date and time” specified in S142 and before the charging table is updated in S141 among the job histories stored in the storage device 27, that is, all job histories that do not include execution results of job for which charging is executed by using the charging table after the update in S141 and in which aggregation is not performed yet (S143), and stores the aggregated data generated in S143 in the storage device 27 (S144).

Next, the aggregated data generator 28c correlates an aggregated data ID of the aggregated data stored in S144 with the respective charging table IDs of the printing fee table 27c and the scanning fee table 27d stored in the storage device 27 and stores the correlation results in the correspondence relationship information 27g (S145), and finishes the operation shown in FIG. 12.

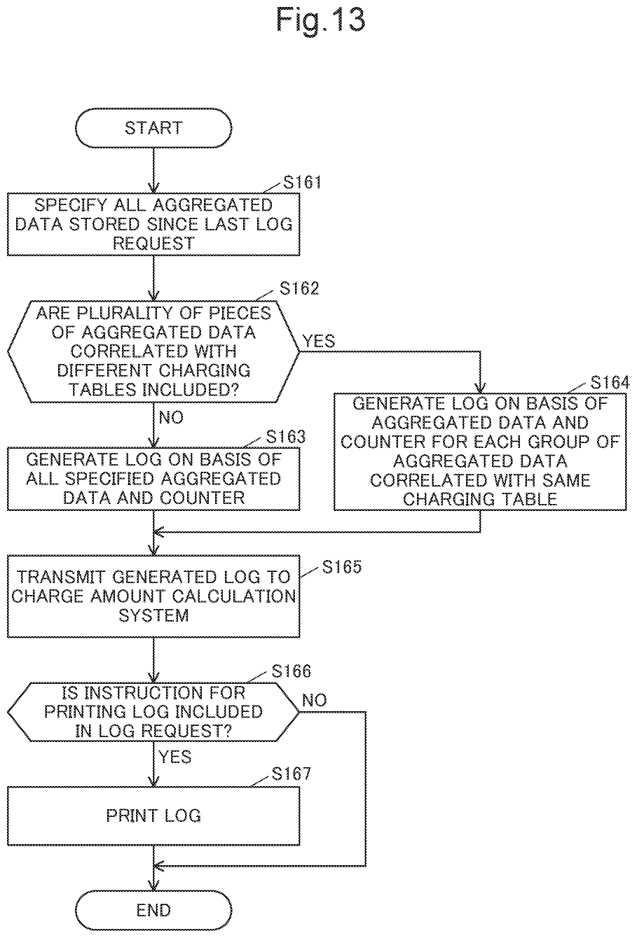

Next, an operation of the image processing apparatus 20 in a case where a log is transmitted to the charge amount calculation system 30 will be described. FIG. 13 is a flowchart showing an operation of the image processing apparatus 20 in a case where a log is transmitted to the charge amount calculation system 30.

The aggregated data collector 35b of the charge amount calculation system 30 periodically notifies the image processing apparatus 20 of a request for a log (hereinafter, referred to as a “log request”), for example, every two days or every three days. Here, the aggregated data collector 35b may cause an instruction as to whether or not to print the log in the image processing apparatus 20 to be included in the log request in response to an instruction via, for example, the operation device 31 or the communication device 33. When the charge amount calculation system 30 provides a notification of the log request, the aggregated data transmitter 28d of the image processing apparatus 20 executes an operation shown in FIG. 13.

As shown in FIG. 13, the aggregated data transmitter 28d specifies all aggregated data stored in the storage device 27 that has not yet been transmitted as a log to the charge amount calculation system 30, that is, all aggregated data stored since the last log request from the charge amount calculation system 30 (S161).

Next, the aggregated data transmitter 28d determines whether or not the aggregated data specified in S161 includes a plurality of pieces of aggregated data correlated with different charging tables in the correspondence relationship information 27g (S162).

When it is determined in S162 that the aggregated data specified in S161 does not include a plurality of pieces of aggregated data correlated with different charging tables in the correspondence relationship information 27g, the aggregated data transmitter 28d generates a log on the basis of all the aggregated data specified in S161 and the counter 27h (S163).

When it is determined in S162 that the aggregated data specified in S161 includes a plurality of pieces of aggregated data correlated with different charging tables in the correspondence relationship information 27g, among the aggregated data identified in S161, the aggregated data transmitter 28d generates, for each group of pieces of aggregated data correlated with the same charging table in the correspondence relationship information 27g, a log gathering the pieces of aggregated data on the basis of the aggregated data and the counter 27h (S164). That is, the aggregated data transmitter 28d generates a plurality of logs in S164.

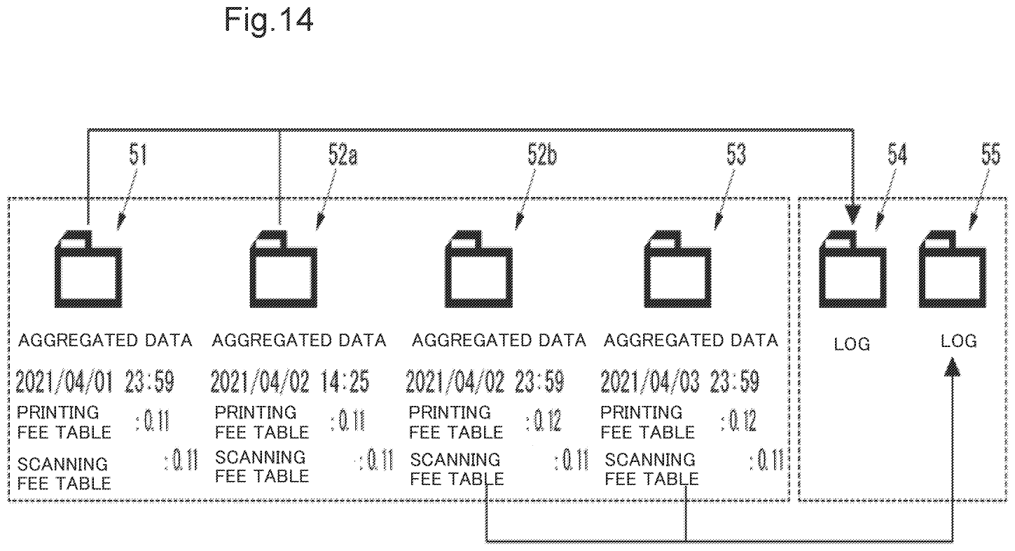

FIG. 14 is a diagram showing an example of a relationship between aggregated data and a log in a case where the image processing apparatus 20 generates a plurality of logs.

FIG. 14 shows aggregated data 51 in which the aggregation execution date and time is “23:59 on Apr. 1, 2021”, aggregated data 52a in which the aggregation execution date and time is “14:25 on Apr. 2, 2021”, aggregated data 52b in which the aggregation execution date and time is “23:59 on Apr. 2, 2021”, aggregated data 53 in which the aggregation execution date and time is “23:59 on Apr. 3, 2021”, a log 54, and a log 55.

The aggregated data 51 and the aggregated data 52a are respectively correlated with “0.11” as a charging table ID of the printing fee table 27c and “0.11” as a charging table ID of the scanning fee table 27d. The aggregated data 52b and the aggregated data 53 are respectively correlated with “0.12” as a charging table ID of the printing fee table 27c, and “0.11” as a charging table ID of the scanning fee table 27d.

In the example shown in FIG. 14, the aggregated data transmitter 28d generates the log 54 on the basis of the aggregated data 51 and the aggregated data 52a in which a combination of the charging table ID of the printing fee table 27c and the charging table ID of the scanning fee table 27d is the same, and also generates the log 55 on the basis of the aggregated data 52b and the aggregated data 53 in which a combination of the charging table ID of the printing fee table 27c and the charging table ID of the scanning fee table 27d is the same.

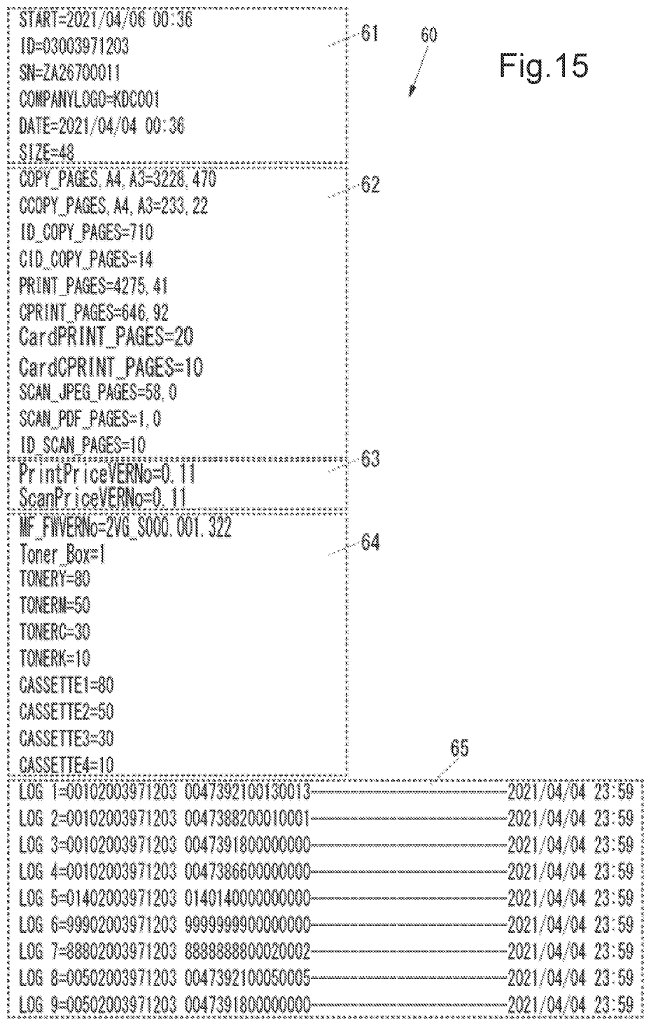

FIG. 15 is a diagram showing an example of a log 60 generated by the image processing apparatus 20.

The log 60 shown in FIG. 15 includes a header 61 of the log 60, counter information 62 based on the counter 27h, charging table ID information 63 indicating a charging table ID correlated with aggregated data included in the log 60, apparatus information 64 of the image processing apparatus 20, and an aggregated data group 65.

FIG. 15 shows that, in the header 61, a value of the item “START” indicating the start date and time of creation of the log 60 is “0:36 on Apr. 6, 2021”, a value of the item “ID” indicating identification information of a store in which the image processing apparatus 20 is installed is “03003971203”, a value of the item “SN” indicating a serial number indicating identification information of the image processing apparatus 20 is “ZA26700011”, a value of the item “COMPANYLOGO” indicating the name of the store in which the image processing apparatus 20 is installed is “KDC001”, a value of the item “DATE” indicating the start date and time of the previous log creation is “0:36 on Apr. 4, 2021”, and a value of the item “SIZE” indicating the number of pieces of aggregated data included in the log 60 is “48”.

FIG. 15 shows that, in the counter information 62, values of the item “COPY PAGES, A4, A3” indicating respective total quantities of the A4 monochrome copying and the A3 monochrome copying are “3228, 470”, that is, a total quantity of A4 monochrome copying and a total quantity of A3 monochrome copying are “3228” and “470”, respectively. FIG. 15 shows that, in the counter information 62, values of the item “CCOPY PAGES, A4, A3” indicating respective total quantities of the A4 color copying and the A3 color copying are “233, 22”, that is, a total quantity of A4 color copying and a total quantity of A3 color copying are “233” and “22”, respectively. FIG. 15 shows that, in the counter information 62, a value of the item “ID COPY PAGES” indicating a total quantity of ID card monochrome copying is “710”, and a value of the item “CID COPY PAGES” indicating a total quantity of ID card color copying is “14”. FIG. 15 shows that, in the counter information 62, values of the item “PRINT PAGE” indicating respective total quantities of A4 monochrome printing and A3 monochrome printing are “4275, 41”, that is, a total quantity of A4 monochrome printing and a total quantity of A3 monochrome printing are “4275” and “41”, respectively. FIG. 15 shows that, in the counter information 62, values of the item “CPRINT PAGES” indicating respective total quantities of A4 color printing and A3 color printing are “646, 92”, that is, a total quantity of A4 color printing and a total quantity of A3 color printing is “646” and “92”, respectively. FIG. 15 shows that, in the counter information 62, a value of the item “CardPRINT PAGES” indicating a total quantity of card monochrome printing is “20”, and a value of the item “CardCPRINT PAGES” indicating a total quantity of card color printing is “10”. FIG. 15 shows that, in the counter information 62, values of the item “SCAN JPEG PAGES” indicating respective total quantities of A4 JPEG scanning and A3 JPEG scanning are “58, 0”, that is, a total quantity of the A4 JPEG scanning and a total quantity of A3 JPEG scanning are “58” and “0”, respectively. FIG. 15 shows that, in the counter information 62, values of the item “SCAN PDF PAGES” indicating respective total quantities of A4 PDF scanning and A3PDF scanning are “1, 0”, that is, a total quantity of A4 PDF scanning and a total quantity of A3 PDF scanning are “1” and “0”, respectively. FIG. 15 shows that, in the counter information 62, a value of the item “ID_SCAN_PAGES” indicating a total quantity of ID card scanning is “10”.

FIG. 15 shows that, in the charging table ID information 63, a value of the item “PrintPriceVERNo” indicating the charging table ID of the printing fee table 27c correlated with the aggregated data included in the log 60 is “0.11”, and a value of the item “ScanPriceVERNo” indicating the charging table ID of the scanning fee table 27d correlated with the aggregated data included in the log 60 is “0.11”. Here, the printing fee table 27c and the scanning fee table 27d include the unit price of a job. Therefore, the log 60 includes the charging table ID information 63 and the aggregated data group 65, and thus the aggregated data is associated with the unit price corresponding to the aggregated data.

FIG. 15 shows that, in the device information 64, a value of the item “MF_FWVERNo” indicating a version of firmware of the image processing apparatus 20 is “2VG S000.001.322”, a value of the item “Toner Box” indicating a remaining capacity of the waste toner box of the image processing apparatus 20 is “1”, a value of the item “TONERY” indicating a remaining amount of yellow toner in the image processing apparatus 20 is “80”, a value of the item “TONERM” indicating a remaining amount of magenta toner in the image processing apparatus 20 is “50”, a value of the item “TONERC” indicating a remaining amount of cyan toner in the image processing apparatus 20 is “30”, a value of the item “TONERK” indicating a remaining amount of black toner in the image processing apparatus 20 is “10”, a value of the item “CASSETTE1” indicating a remaining amount of recording media in the first paper feed cassette of the image processing apparatus 20 is “80”, a value of the item “CASSETTE2” indicating a remaining amount of recording media in the second paper feed cassette of the image processing apparatus 20 is “50”, a value of the item “CASSETTE3” indicating a remaining amount of recording media in the third paper feed cassette of the image processing apparatus 20 is “30”, and a value of the item “CASSETTE4” indicating a remaining amount of recording media in the fourth paper feed cassette of the image processing apparatus 20 is “10”.

In the group 65 shown in FIG. 15, one piece of aggregated data is shown for each row.

As shown in FIG. 13, the aggregated data transmitter 28d transmits the log generated in S163 or S164 to the charge amount calculation system 30 as a response to the log request after the process in S163 or S164 (S165).

Next, the aggregated data transmitter 28d determines whether or not the log request includes an instruction for printing the log in the image processing apparatus 20 (S166).

When the aggregated data transmitter 28d determines in S166 that the log request includes an instruction for printing the log in the image processing apparatus 20, the printer 23 prints the log generated in S163 or S164 (S167). Therefore, an administrator of the image processing apparatus 20 can check details of the log transmitted from the image processing apparatus 20 to the charge amount calculation system 30 from printed matter by the printer 23.

When the aggregated data transmitter 28d determines in S166 that the instruction for printing the log in the image processing apparatus 20 is not included in the log request, or the process in S167 is finished, the operation shown in FIG. 13 is finished.

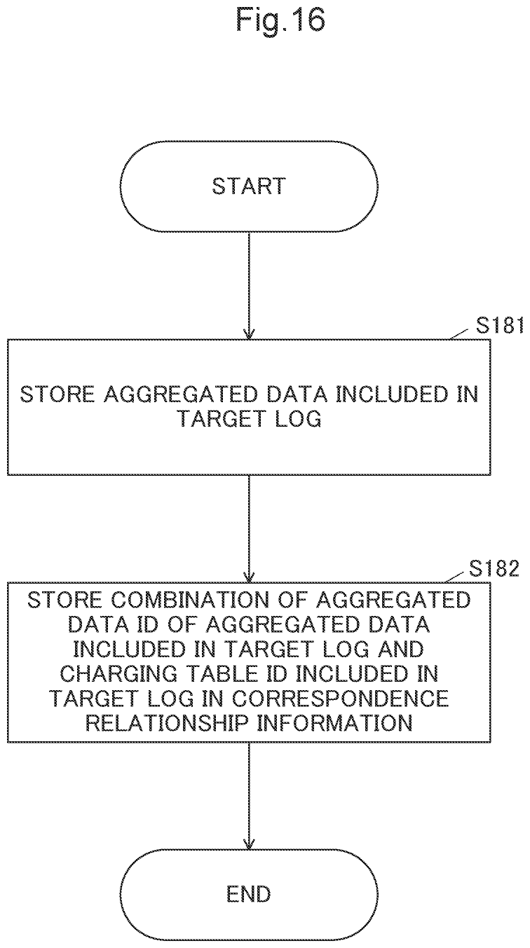

Next, an operation of the charge amount calculation system 30 in a case where a log is received will be described. FIG. 16 is a flowchart showing an operation of the charge amount calculation system 30 in a case where a log is received.

Upon receiving the log (hereinafter, referred to as a “target log” in the description of the operation shown in FIG. 16) transmitted from the image processing apparatus, the aggregated data collector 35b of the charge amount calculation system 30 executes the operation shown in FIG. 16.

As shown in FIG. 16, the aggregated data collector 35b stores the aggregated data included in the target log in the storage device 34 in correlation with the serial number of the image processing apparatus included in the target log (S181).

Next, the aggregated data collector 35b stores a combination of the aggregated data ID of the aggregated data included in the target log and the charging table ID included in the target log in the correspondence relationship information 34e (S182), and finishes the operation shown in FIG. 16.

FIG. 16 shows a specific operation using the aggregated data and the charging table ID included in the target log. However, the charge amount calculation system 30 may execute various operations based on various types of information included in the target log.

Next, an operation of the charge amount calculation system 30 in a case where a charge amount in the image processing apparatus is calculated will be described.

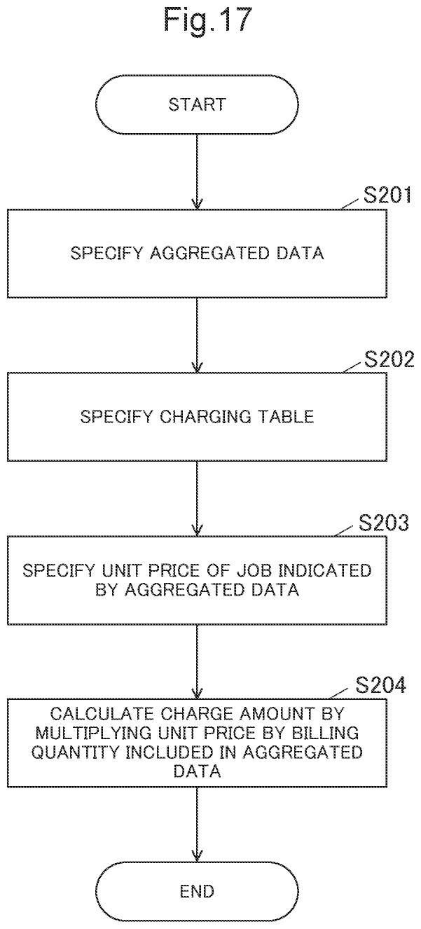

FIG. 17 is a flowchart showing an operation of the charge amount calculation system 30 in a case where a charge amount in the image processing apparatus is calculated.

The charge amount calculator 35c of the charge amount calculation system 30 executes the operation shown in FIG. 17 in a specific case such as a case where an instruction is received via the operation device 31 or the communication device 33.

As shown in FIG. 17, the charge amount calculator 35c specifies one piece of aggregated data designated by a user in one image processing apparatus designated by the user among the pieces of aggregated data stored in the storage device 34 (S201). Here, in the charge amount calculator 35c, for example, the image processing apparatus and the aggregated data may be designated by an instruction via the operation device 31 or the communication device 33.

After the process in S201, the charge amount calculator 35c specifies a charging table correlated with the aggregated data specified in S201 in the correspondence relationship information 34e among the charging tables stored in the storage device 34 (S202).

Next, the charge amount calculator 35c specifies the unit price of the job indicated by the aggregated data by using the charging table specified in S202 (S203).

Next, the charge amount calculator 35c calculates a charge amount of the job indicated by the aggregated data by multiplying the unit price specified in S203 by the billing quantity included in the aggregated data specified in S201 (S204), and finishes the operation shown in FIG. 17.

The charge amount calculator 35c calculates a charge amount on the basis of one piece of aggregated data for one image processing apparatus in the operation shown in FIG. 17. However, the charge amount calculator 35c can similarly calculate a charge amount on the basis of a plurality of pieces of aggregated data by calculating the charge amount on the basis of aggregated data and a charging table corresponding to the aggregated data. For example, a plurality of pieces of aggregated data may be designated by designating a period of the aggregation execution date and time. The plurality of pieces of aggregated data may be aggregated data for one image processing apparatus or may be aggregated data for a plurality of image processing apparatuses.

As described above, in a case where the unit price of a job is changed (S141), the image processing apparatus 20 separately generates aggregated data of the job before the change of the unit price and aggregated data of the job after the change of the unit price (S122 and S143), stores and manages the unit price corresponding to the generated aggregated data (S124 and S145), and transmits the aggregated data to the charge amount calculation system 30 in association with the unit price corresponding to the aggregated data (S165). Therefore, it is possible to prevent a billing quantity of the job before the change of the unit price and a billing quantity of the job after the change of the unit price from being totaled and included in the same aggregated data, and as a result, a charge amount in the image processing apparatus 20 may be appropriately calculated by the charge amount calculation system 30.

In a general information processing system, in a case where the unit price of a job is changed, when a billing quantity of the job before the change of the unit price and a billing quantity of the job after the change of the unit price are totaled and included in the same aggregated data, there is a problem in that a charge amount in a job execution apparatus cannot be correctly calculated by a charge amount calculation system on the basis of this aggregated data. On the other hand, according to the above embodiment, a charge amount in the image processing apparatus 20 can be appropriately calculated by the charge amount calculation system 30.

In a case where the charge amount calculation system 30 can appropriately calculate a charge amount in the image processing apparatus 20, for example, it is possible to allow an operator of the charge amount calculation system 30 to check whether or not a total amount of money actually paid by a user of the image processing apparatus 20 is different from a charge amount calculated by the charge amount calculation system 30.

When the charge amount calculation system 30 can appropriately calculate a charge amount in the image processing apparatus 20, for example, in a case of a contract in which a person who causes a user of the image processing apparatus 20 to use the image processing apparatus 20 (hereinafter, an “apparatus operator”) is different from a person who provides the image processing apparatus 20 to the apparatus operator (hereinafter, referred to as an “apparatus provider”), and an amount of money corresponding to a charge amount in the image processing apparatus 20 is paid by the apparatus operator to the apparatus provider, an amount of money paid by the apparatus operator to the apparatus provider can be appropriately calculated.

The image processing apparatus 20 generates aggregated data indicating an aggregated result of a billing quantity that has not been aggregated yet for a job before a change of the unit price, triggered by the change of the unit price of the job (S143), and can thus generate aggregated data of the job before the change of the unit price each time the unit price is changed, and as a result, it is possible to reduce a probability that a processing burden of generating the aggregated data is concentrated at one time.

The image processing apparatus 20 transmits a log including aggregated data indicating an aggregated result of billing quantities of a plurality of jobs to the charge amount calculation system 30 (S165) instead of sending a billing quantity of a job to the charge amount calculation system 30 each time the job is executed, and thus it is possible to reduce an amount of communication with the charge amount calculation system 30.

In the present embodiment, the aggregated data transmitter 28d of the image processing apparatus 20 transmits a log to the charge amount calculation system 30 every time a notification of a log request is provided from the charge amount calculation system 30. However, the aggregated data transmitter 28d may periodically transmit a log to the charge amount calculation system 30, for example, every two days or every three days, even if a notification of a log request is not provided from the charge amount calculation system 30.

While the present disclosure has been described in detail with reference to the embodiments thereof, it would be apparent to those skilled in the art the various changes and modifications may be made therein within the scope defined by the appended claims.

What is claimed is:

1. A job execution apparatus that executes jobs, comprising:
a control device that includes a processor, and, by the processor executing an information processing program, functions as
a job execution device that executes the jobs,
an aggregated data generator that generates aggregated data indicating an aggregated result of a quantity for each type of job that is a target of charging with respect to each of the jobs executed by the job execution device, and
an aggregated data transmitter that transmits each piece of the aggregated data generated by the aggregated data generator to a charge amount calculation system that calculates a charge amount in the job execution apparatus, wherein
in a case where a unit price of the charging for any of the jobs is changed, the aggregated data generator separately generates the aggregated data for a job executed before the unit price is changed and the aggregated data for a job executed after the unit price is changed, and stores the unit price corresponding to each of the pieces of generated aggregated data, and
the aggregated data transmitter associates each of the pieces of aggregated data before and after the unit price is changed with the unit price corresponding to each of the pieces of aggregated data and transmits the aggregated data to the charge amount calculation system.

2. The job execution apparatus according to claim 1, wherein
the jobs are classified according to functions to be executed,
the job execution apparatus further comprises a storage device that stores each charging table in which the unit price is prepared for each function,
the aggregated data generator reads the charging table correlated with a function of the job from the storage device, and uses a unit price indicated by the read charging table to generate aggregated data indicating an aggregated result of a quantity for each type of job, and
in a case where each of the pieces of aggregated data is transmitted to the charge amount calculation system, when a plurality of pieces of aggregated data correlated with different charging tables are generated by the aggregated data generator, the aggregated data transmitter generates a log gathering pieces of aggregated data for each group of aggregated data correlated with the same charging table among the plurality of pieces of aggregated data.

3. The job execution apparatus according to claim 1, wherein
when the unit price is changed, the aggregated data generator generates the aggregated data indicating the aggregated result of the quantity that has not been aggregated for the job executed before the unit price is changed.

4. A non-transitory computer readable recording medium that stores a data processing program, the data processing program being executed by a computer to control the computer to function as:
an aggregated data generator that generates aggregated data indicating an aggregated result of a quantity for each type of job that is a target of charging with respect to each of the jobs executed by the computer; and
an aggregated data transmitter that transmits each piece of the aggregated data generated by the aggregated data generator to a charge amount calculation system that calculates a charge amount in the job execution apparatus, wherein
in a case where a unit price of the charging for any of the jobs is changed, the aggregated data generator separately generates the aggregated data for a job executed before the unit price is changed and the aggregated data for a job executed after the unit price is changed, and stores the unit price corresponding to each of the pieces of generated aggregated data, and
the aggregated data transmitter associates each of the pieces of aggregated data before and after the unit price is changed with the unit price corresponding to each of the pieces of aggregated data and transmits the aggregated data to the charge amount calculation system.

5. An information processing system comprising:
a job execution apparatus that executes jobs; and
a charge amount calculation system that calculates a charge amount in the job execution apparatus, wherein
the job execution apparatus includes
a control device that includes a processor, and, by the processor executing an information processing program, functions as
a job execution device that executes the jobs,
an aggregated data generator that generates aggregated data indicating an aggregated result of a quantity for each type of job that is a target of charging with respect to each of the jobs executed by the job execution device, and
an aggregated data transmitter that transmits each piece of the aggregated data generated by the aggregated data generator to the charge amount calculation system, and
in a case where a unit price of the charging for any of the jobs is changed, the aggregated data generator separately generates the aggregated data for a job executed before the unit price is changed and the aggregated data for a job executed after the unit price is changed, and stores the unit price corresponding to each of the pieces of generated aggregated data, and
the aggregated data transmitter associates each of the pieces of aggregated data before and after the unit price is changed with the unit price corresponding to each of the pieces of aggregated data and transmits the aggregated data to the charge amount calculation system.
